(19) United States
(12) Patent Application Publication
(10) Pub. No.: US 2018/0034908 A1
(43) Pub. Date: Feb. 1, 2018

(54) DISAGGREGATED STORAGE AND COMPUTATION SYSTEM

(71) Applicant: Alibaba Group Holding Limited, George Town (KY)

(72) Inventor: Shu Li, Bothell, WA (US)

(21) Appl. No.: 15/221,229

(22) Filed: Jul. 27, 2016

(51) Int. Cl. H04L 29/08

(52) U.S. Cl. CPC H04L 67/1097; H04L 67/1031; H04L 67/16; H04L 67/1008

(57) ABSTRACT

A disaggregated system is disclosed. The disaggregated system includes one or more computation nodes and one or more storage nodes. The one or more computation nodes and one or more storage nodes of the disaggregated system work in concert to provide one or more services. Existing computation nodes and existing storage nodes in the disaggregated system can be removed as less computation capacity and storage capacity, respectively, are needed by the system. Additional computation nodes and existing storage nodes in the disaggregated system can be added as more computation capacity and storage capacity, respectively, are needed by the system.

### BACKGROUND OF THE INVENTION

Conventionally, data servers operate in a data center to perform more services in parallel. The cost to implement a data server is expensive and each additional data server may provide more storage and/or computation capacity than is actually needed. As such, the conventional means of accommodating a greater storage and/or computation need by adding additional servers may be wasteful as typically, at least some of the added capacity may not be used.

### BRIEF DESCRIPTION OF THE DRAWINGS

Various embodiments of the invention are disclosed in the following detailed description and the accompanying drawings.

FIG. 1 is a diagram showing conventional servers and an Ethernet switch in a data center.

FIGS. 2A and 2B are diagrams showing the configured CPU and RAM capacities of a conventional server and the CPU and RAM capacities that are needed by two different services.

FIGS. 3A and 3B are diagrams showing the configured CPU and RAM capacities of a conventional server and the CPU and RAM capacities that are needed by the same service over time.

FIG. 4 is a diagram showing various storage nodes and computation nodes in an example disaggregated computation and storage system in accordance with some embodiments.

FIG. 5 is a diagram showing an example disaggregated system of computation nodes and storage nodes that is connected to an Ethernet switch and also to a set of common external equipment that is shared by the disaggregated system.

FIG. 6 is a flow diagram showing an embodiment of a process for adding a new node to a disaggregated system.

FIG. 7 is a flow diagram showing an embodiment of a process for removing an existing node from a disaggregated system.

FIG. 8 is an example of a computation node.

FIG. 9 is an example of a storage node.

FIG. 10 shows a comparison between an example conventional server rack and a server rack with an example disaggregated system.

FIG. 11 is a diagram showing example disaggregated systems connected to other systems in a data center.

### DETAILED DESCRIPTION

The invention can be implemented in numerous ways, including as a process; an apparatus; a system; a composition of matter; a computer program product embodied on a computer accessible/readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a storage module and/or memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

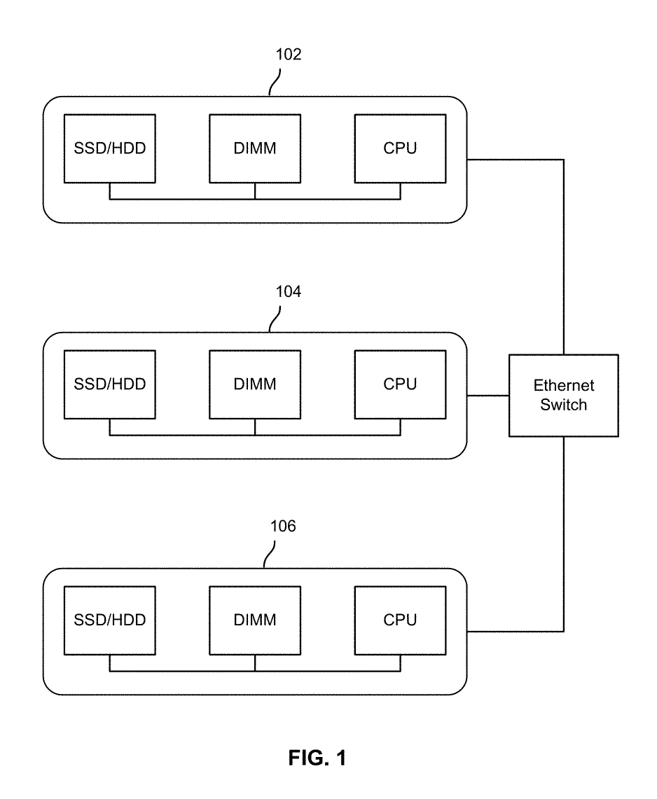

FIG. 1 is a diagram showing conventional servers and an Ethernet switch in a data center. As shown in the diagram, each of servers 102, 104, and 106 is an example of a conventional server. Each server is configured with a fixed amount of storage components (e.g., solid state drive (SSD)/hard disk drive (HDD), dual in-line memory module (DIMM)) and a fixed amount of computation components (e.g., central processing unit (CPU)). As such, each server is a stand-alone machine with its own fixed storage capacity, CPU capacity, and memory capacity. Typically, the input/output (10) ratio and capacity are configured once at server build-up for a conventional server. One main disadvantage of the fixed configuration of the conventional server is that varying types and volumes of service requests sent from clients may not be fully accommodated by the server's fixed configuration.

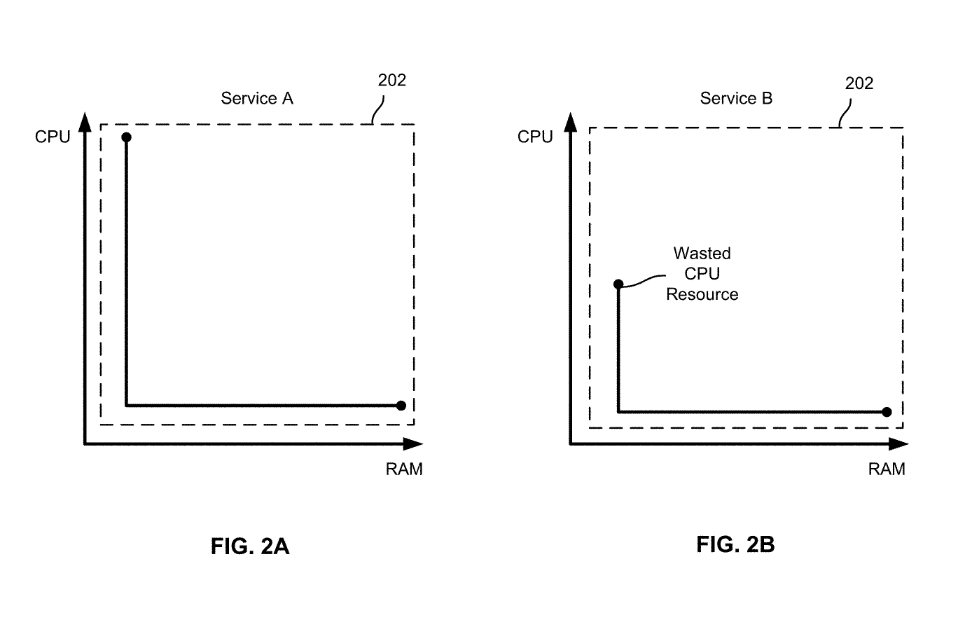

FIGS. 2A and 2B are diagrams showing the configured CPU and RAM capacities of a conventional server and the CPU and RAM capacities that are needed by two different services. In the plots in FIGS. 2A and 2B, dotted line 202 denotes the configured, fixed CPU and RAM capacities of a conventional server. Often, a conventional server is configured to accommodate multiple services. However, the varied CPU and RAM maximum needs of different services may cause the server to be configured with more capacity of one or more resource types than is needed for certain services, thereby causing those excess resources to be wasted. Therefore, in a conventional server, CPU, memory, storage, or a combination thereof can be wasted in providing multiple services. In the example of FIGS. 2A and 2B, the server's configuration is tailored for providing Service A to clients. As such, as shown in FIG. 2A, the CPU and RAM capacities that are needed by Service A are satisfied by the fixed CPU and RAM capacities of the server, as delineated by dotted line 202. However, because the server's configuration was not tailored for providing service B to clients, as shown in the plot in FIG. 2B, the CPU capacity that is needed by Service B is far less than what is offered by the fixed CPU capacity of the server, as delineated by dotted line 202. Therefore, the fixed CPU capacity of the server becomes inevitably wasted during certain times, such as when the server is processing Service B's requests.

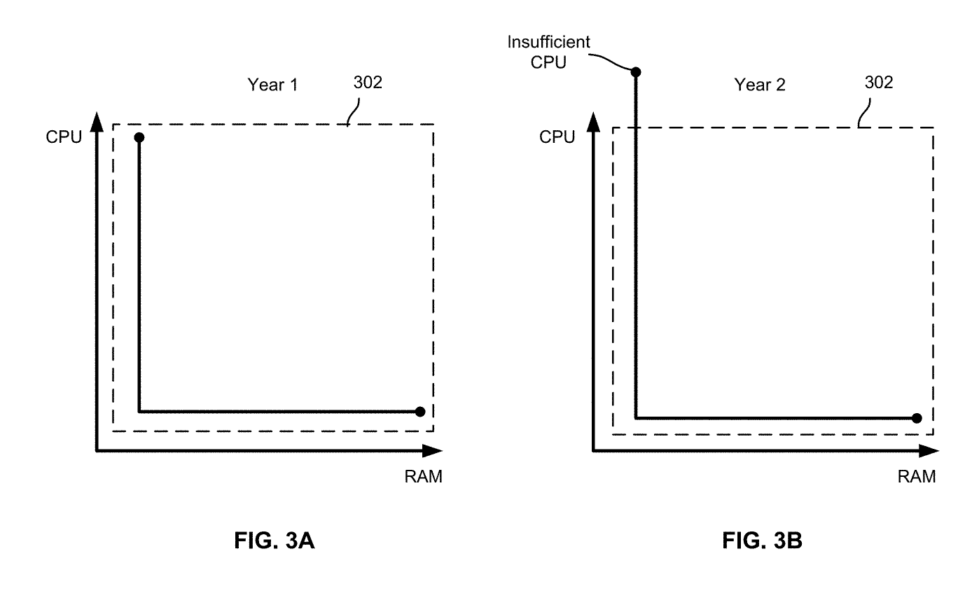

FIGS. 3A and 3B are diagrams showing the configured CPU and RAM capacities of a conventional server and the CPU and RAM capacities that are needed by the same service over time. In the plots in FIGS. 3A and 3B, dotted line 302 denotes the configured, fixed CPU and RAM capacities of a conventional server. To justify the cost of a new server, the server is typically in use for three or more years in a data center before it is retired. However, over time, the demand for the same service may change. In the example, the server's configuration is tailored for providing a particular service and appears to satisfy the CPU and RAM capacities that are needed by that particular service during the first year of the server's lifetime. However, because the CPU and RAM capacities that are needed of the server may increase over time, as shown in the plot of FIG. 3B, the fixed CPU capacity of the server becomes insufficient to meet the CPU needs of the service by the second year of the server's lifetime. Conventionally, to solve the problem of an insufficient resource that is needed for providing a service, more servers can be added to the data center to scale up the computation power of the data center. However, if an additional server cannot be added due to limitations and constraints, the old server has to be replaced with a whole new server that includes at least as much of the resource (e.g., memory) that became insufficient over time.

Servers and Ethernet switches are the main components of the traditional data center. Simply speaking, the traditional data center includes servers connected with Ethernet and with various other equipment such as out of band (OOB) communication equipment, cooling system, a back-up battery unit (BBU), a power distribution unit (PDU), racks, a secondary power supply, a petrol power generator, etc. In various embodiments, a BBU temporarily provides power to a system when the primary and/or secondary power supplies are unavailable. Nowadays, because servers could be configured and then later deployed online for different applications and at different times, a data center could include servers with different configurations. The diversified server types can temporarily provide applications with tailored improvement at certain periods. However, given the long-term development of the data center, the diversified conventional server types can also cause more and more problems with respect to management, fault control, maintenance, migration and further scale-out, for example.

Another problem lies in the varying demands from end users. It is unlikely that regular rules or characteristics of a conventional server can accommodate the varying service demands of clients for a long period. Therefore, one server configuration may soon become out-of-date, and therefore difficult to be used over a long period by various applications. In other words, conventional servers with fixed configurations may only be used for a short period, but remain idle in the resource pool without further usage until the expiration of the warranty.

Embodiments of a disaggregated computation and storage system are described herein. In various embodiments, a disaggregated computation and storage system (which is sometimes referred to as a “disaggregated system”) comprises separate storage components and computations components. In various embodiments, each unit of a storage component is referred to as a “storage node” and each unit of a computation component is referred to as a “computation node.” In various embodiments, a disaggregated system comprises one or more computation nodes and zero or more storage nodes. In various embodiments, each computation node in the disaggregated system does not include a storage drive (e.g., a hard disk drive (HDD) or solid-state drive (SSD)) and instead includes a central processing unit (CPU), a storage configured to provide the CPU with operating system code, one or more memories configured to provide the CPU with instructions, and a networking interface configured to communicate with at least one of the storage nodes in the same system (e.g., via an Ethernet switch). In various embodiments, each storage node in the disaggregated system does not include a CPU and instead includes one or more storage devices configured to store data, a controller (with an embedded microprocessor) configured to control the one or more storage devices, one or more memories configured to provide instructions to the controllers, and a networking interface configured to communicate with at least one of the computation nodes. In various embodiments, the computation nodes and the storage nodes of the same disaggregated system are configured to collectively provide one or more services. In various embodiments, at least one computation node in a disaggregated system comprises a “master computation node” that will receive a request (e.g., from a load balancer or a client) to be processed by the disaggregated system, distribute the request to one or more computation and/or storage nodes in the disaggregated system, and return a result of the performed request back to the requestor, if appropriate. In various embodiments, computation nodes can be dynamically and flexibly added to or removed from the disaggregated system for additional or reduced computation/processing as needed, without wasting excess/unused storage and/or computation capacity. In various embodiments, each computation and/or storage node is associated with the dimensions of a card (e.g., a half-height full-length (HHFL) add-in-card (AIC)) such that the computation and/or storage nodes associated with the same disaggregated system can be installed across the same shelf of a server rack. As such, multiple disaggregated systems can be installed within the same server rack, for an efficient usage of server rack space.

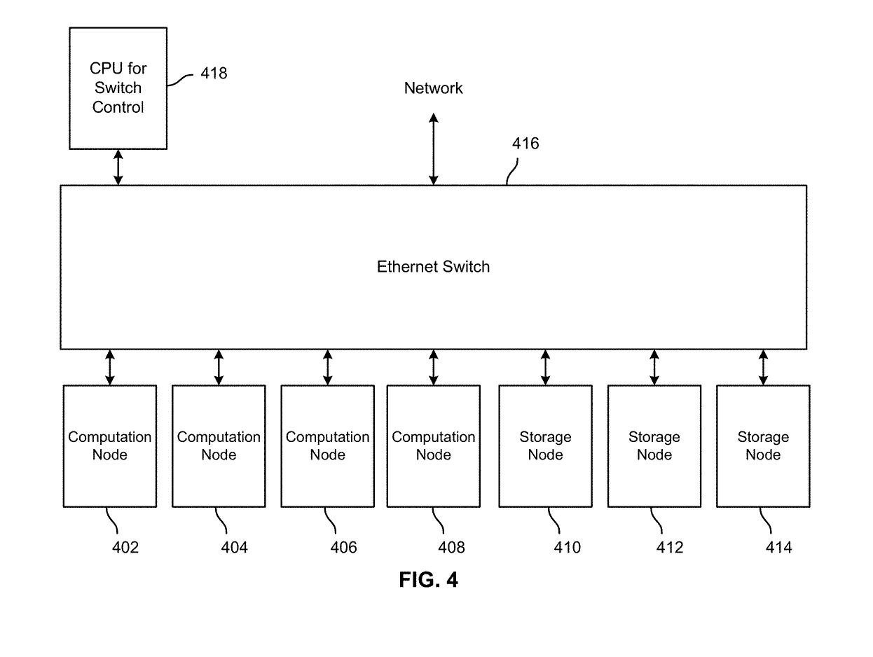

FIG. 4 is a diagram showing various storage nodes and computation nodes in an example disaggregated computation and storage system in accordance with some embodiments. As shown in the example of FIG. 4, computation nodes 402, 404, 406, and 408 and storage nodes 410, 412, and 414 form a single disaggregated system and are also connected to Ethernet switch 416. Each of computation nodes 402, 404, 406, and 408 and storage nodes 410, 412, and 414 is not in itself a conventional server but a small card with a compact form factor. For example, each of computation nodes 402, 404, 406, and 408 can be implemented on a single printed circuit board (PCB) and each of storage nodes 410, 412, and 414 can be implemented on a single PCB. Each of computation nodes 402, 404, 406, and 408 and storage nodes 410, 412, and 414 is directly connected to Ethernet switch 416 for a super-fast interconnect to each other, other systems, and/or the Ethernet fabric. Each of computation nodes 402, 404, 406, and 408 and storage nodes 410, 412, and 414 is associated with a corresponding identifier and a corresponding Internet Protocol (IP) address. Ethernet switch 416 can provide, for example, 128×25 Gb of bandwidth, which can be used to facilitate communication between the storage nodes and computation nodes in the disaggregated system and between the disaggregated system and the external equipment and/or other systems in a data center over a network (e.g., the Internet or other high-speed telecommunications and/or data networks). CPU for switch control 418 is configured to provide instructions to Ethernet switch 416. Examples of CPU for switch control 418 include ×86 or ARM CPUs. CPU for switch control 418 can run a protocol such as Broadcom®'s Tomahawk, for example. In contrast to a master computation node, which is configured to manage a disaggregated system's operations, CPU for switch control 418 is configured to control Ethernet switch 416 associated with the disaggregated system.

As will be described in further detail below, each of computation nodes 402, 404, 406, and 408 and storage nodes 410, 412, and 414 includes fewer components/resources than is typically configured for a server and all of the nodes, regardless of whether they are computation nodes or storage nodes, are configured to work together to collectively provide one or more services to clients. In various embodiments, each disaggregated system includes one or more computation nodes and zero or more storage nodes. At least one computation node in each disaggregated system is sometimes referred to as the “master computation node” and the master computation node is configured to receive requests from clients (e.g., via a load balancer) for one or more services, distribute the requests to one or more other computation and/or storage nodes, aggregate responses from the one or more other computation and/or storage nodes, and return an aggregated response to the requesting clients. In some embodiments, the master computation node in a disaggregated system will store the identifiers and/or the IP addresses of each storage node and computation node that is included in the same disaggregated system as the master computation node so that these member nodes can be grouped together and managed by the master computation node. In some embodiments, the master computation node stores logic that determines how many computation nodes and/or storage nodes are needed to perform each service that the disaggregated system is configured to perform. In some embodiments, a client request to a disaggregated system is first received by the system's master computation node and the master computation node will distribute the request among the other computation nodes and the storage nodes of the system. In some embodiments, the master computation node in a disaggregated system can divide a received client request into multiple partial requests and distribute each of the partial requests to a different node in the system. In some embodiments, nodes that have received a partial request will at least process the partial request (e.g., perform a computation, retrieve at least a portion of a requested file, store at least a portion of a requested file, delete at least a point of a requested file, perform a specified operation on at least a portion of a requested file, etc.) and then send the response to the partial request back to the master computation node. The master computation node can aggregate/combine/reconcile the responses to the partial requests that have been received from the other nodes in the system, generate an aggregated/combined response (e.g., combine various portions of a requested file into the complete file) to the request, and return the aggregated/combined response back to the requesting client.

The following is an example of a master computation node managing the computation and storage nodes in a disaggregated system: The master computation node of a disaggregated system receives a client request to resize an image that is stored at the system. The master computation node uses the distributed file system stored on the node to determine which storage nodes of the system includes (portions of) the file. The master computation node also maintains metadata regarding the current work load and/or availability of each computation node and each storage node in the disaggregated system (e.g., the computation nodes and storage nodes can periodically send feedback regarding their current work load and/or availability to the master computation node). The master computation node can then break down the client request for resizing an image into several partial requests and assign the partial requests to the appropriate storage nodes and computation nodes of the system based on the distributed file system and the stored metadata. For example, the master computation node can break down the request for resizing an image into a first partial request to retrieve the requested image and a second partial request to resize the image to the specified size. The master computation node can then assign the first partial request to retrieve the requested image from the storage node that stores the requested file and send the second partial request to resize the image to the specified size to a computation node that has enough availability computation capacity to perform the task. After the computation node returns the resized image to the master computation node, the master computation node can respond to the client request by sending the resized image to the requestor.

In various embodiments, the master computation node of a disaggregated system is configured to store a distributed file system that keeps track of which other nodes store which portions of files that are maintained by the system. Examples of distributed file systems include the Hadoop distributed file system or Alibaba's Pangu distributed file system. In some embodiments, only storage nodes in a disaggregated system store user files. While each computation node includes a relatively small memory capacity, the memory installed in a computation node is configured to store the operating system code for boot up of the computation node.

In various embodiments, as storage nodes and/or computation nodes of a disaggregated system fail and/or need to be replaced for other reasons, new storage nodes and/or computation nodes can be used to replace the failed storage or computation node. In some embodiments, the new storage node or new computation node can replace the previous corresponding storage node or computation node in a manner that does not require the entire disaggregated system to be shut down. For example, when a new node (e.g., a card) is plugged into the system and powered on, it broadcasts a message announcing its presence. Upon receiving the message, the master computation node assigns an (e.g., IP) address to the new node, and from that point on the master computation node communicates with the new node via the Ethernet switch.

In various embodiments, additional storage nodes and/or computation nodes of a disaggregated system can be flexibly added to the disaggregated system in the event that additional storage and/or computation capacity is desired. In some embodiments, the new storage node or new computation node can be hot plugged to the disaggregated system. In some embodiments, “hot plugging” the new storage node or new computation node into the disaggregated system refers to the new storage node or new computation node being added to, recognized by, and initialized by the disaggregated system in a manner that does not require the entire disaggregated system to be shut down.

In various embodiments, one or more storage nodes and/or computation nodes of a disaggregated system can be flexibly removed from the disaggregated system in the event that reduced storage and/or computation capacity is desired. In some embodiments, the existing storage node or existing computation node can be removed from the disaggregated system in a manner that does not require the entire disaggregated system to be shut down.

In various embodiments, besides one computation node, which is configured to be the master computation node, a disaggregated system may have zero or more other computation nodes and zero or more storage nodes. In some embodiments, the maximum number of computation and/or storage nodes that a disaggregated system can have is at least limited by the total power budget of the server rack. For example, the number of computation and/or storage nodes that can be included in a single disaggregated system is limited by the total power budget of a server rack divided by the power consumption of a computation node and/or storage node.

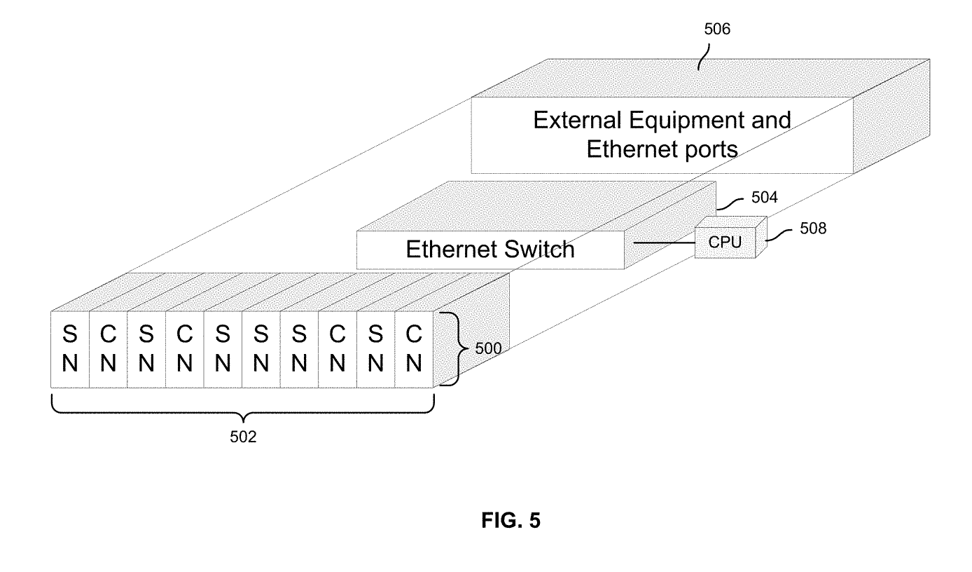

FIG. 5 is a diagram showing an example disaggregated system of computation nodes and storage nodes that is connected to an Ethernet switch and also to a set of common external equipment that is shared by the disaggregated system. In the example, “S N” represents a storage node and “C N” represents a computation node. As shown in the example, disaggregated system 502 includes several computation nodes and several storage nodes that collectively perform one or more services associated with disaggregated system 502. Ethernet switch 504 (e.g., a 128×25 Gb Ethernet switch) sits behind disaggregated system 502. A (e.g., ARM-architecture) CPU (not shown in the diagram) can be assigned for the control purpose of the Ethernet. External equipment and Ethernet ports 506 are installed next to Ethernet switch 504. Ethernet switch 504 is controlled by CPU for switch control 508. External equipment and Ethernet ports 506 are shared by all nodes of disaggregated system 502. Example external equipment includes, for example, one or more of the following: out of band (OOB) communication equipment (e.g., a serial port, a USB port, an Ethernet port, or the like configured to transfer data through a stream that is independent from the main in-band data stream), a cooling system, a BBU, a power distribution unit (PDU), racks, a secondary power supply, a petrol power generator, and a fan. Ethernet ports can be used to connect disaggregated system 502 to other systems in a data center. In some embodiments, the disaggregated system is installed in a server rack such that the storage nodes and/or computation nodes are front facing the cold aisle (e.g., an aisle in a data center that face air conditioner output ducts).

In some embodiments, the height of disaggregated system 502 (and therefore the height of each of the computation nodes and storage nodes that form disaggregated system 502) is predetermined. In some embodiments, height 500 of disaggregated system 502 (and therefore the height of each of the computation nodes and storage nodes that form disaggregated system 502) is two rack units (RU). In some embodiments, the server rack on which one or more disaggregated systems are installed is a 19 inch-wide rack. In some embodiments, the server rack on which one or more disaggregated systems are installed is a 23 inch-wide rack. Given that the typical full rack size is 48 RU, multiple disaggregated systems can be installed within a single server rack.

In some embodiments, disaggregated system 502 can receive a request from a client via a load balancer, which can distribute requests to one or more disaggregated systems and/or one or more conventional servers based on a configured distribution policy.

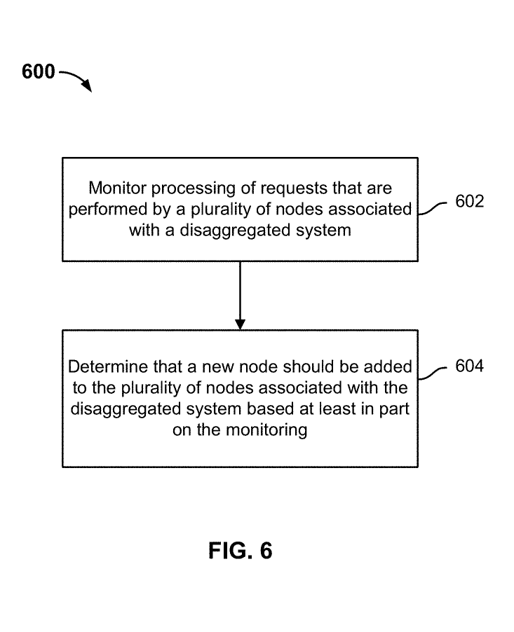

FIG. 6 is a flow diagram showing an embodiment of a process for adding a new node to a disaggregated system. In some embodiments, process 600 is implemented at a disaggregated system such as the disaggregated system described in FIG. 4.

At 602, processing of requests that are performed by a plurality of nodes associated with a disaggregated system is monitored. Various characteristics (e.g., volume, speed, type of requests, type of requestors, etc.) associated with how requests are processed by the storage and/or computation nodes of a disaggregated system can be monitored over time. The monitored characteristics and/or characteristics of future performances that are extrapolated from the monitored performance can be compared against configured criteria (e.g., thresholds or conditions) for adding a new storage node or a new computation node to the disaggregated system.

At 604, it is determined that a new node should be added to the plurality of nodes associated with the disaggregated system based at least in part on the monitoring. In the event that the configured criteria (e.g., thresholds or conditions) for adding a new storage or a new computation node to the disaggregated system are met, then a new node associated with the met criteria is added to the disaggregated system. For example, if criteria for adding a new storage node are met, then a new storage node is added to the disaggregated system. Otherwise, if criteria for adding a new computation node are not met, then a new computation node is not added to the disaggregated system. For example, the master computation node monitors (e.g., by polling the nodes or by receiving periodic updates from the nodes) the amount of CPU/memory usage needed by the nodes, and when the usage exceeds a threshold, a new node would be added to the disaggregated system. In some embodiments, when such a threshold is exceeded, an alert is sent to an administrative user who can submit a command to confirm the addition of a new node to the system.

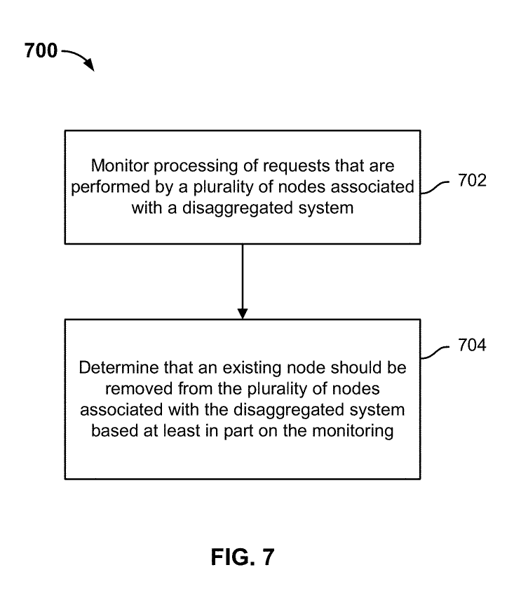

FIG. 7 is a flow diagram showing an embodiment of a process for removing an existing node from a disaggregated system. In some embodiments, process 700 is implemented at a disaggregated system such as the disaggregated system described in FIG. 4.

At 702, processing of requests that are performed by a plurality of nodes associated with a disaggregated system is monitored. Various characteristics (e.g., volume, speed, type of requests, type of requestors, etc.) associated with how requests are processed by the storage and/or computation nodes of a disaggregated system can be monitored over time. The monitored characteristics and/or characteristics of future performances that are extrapolated from the monitored performance can be compared against configured criteria (e.g., thresholds or conditions) for removing an existing storage node or an existing computation node from the disaggregated system.

At 704, it is determined that an existing node should be removed from the plurality of nodes associated with the disaggregated system based at least in part on the monitoring. In the event that the configured criteria (e.g., thresholds or conditions) for removing an existing storage or an existing computation node from the disaggregated system are met, then an existing node associated with the met criteria is removed from the disaggregated system. For example, if criteria for removing an existing storage node are met, then an existing storage node is removed from the disaggregated system. Otherwise, if criteria for removing an existing computation node are not met, then an existing computation node is not removed from the disaggregated system. For example, the master computation node monitors (e.g., by polling the nodes or by receiving periodic updates from the nodes) the amount of CPU/memory usage needed by the nodes, and when the usage falls below a threshold, a new node would be added to the disaggregated system. In some embodiments, when the usage falls below a threshold, and alert is sent to an administrative user who can submit a command to confirm the removal of an existing node from the system.

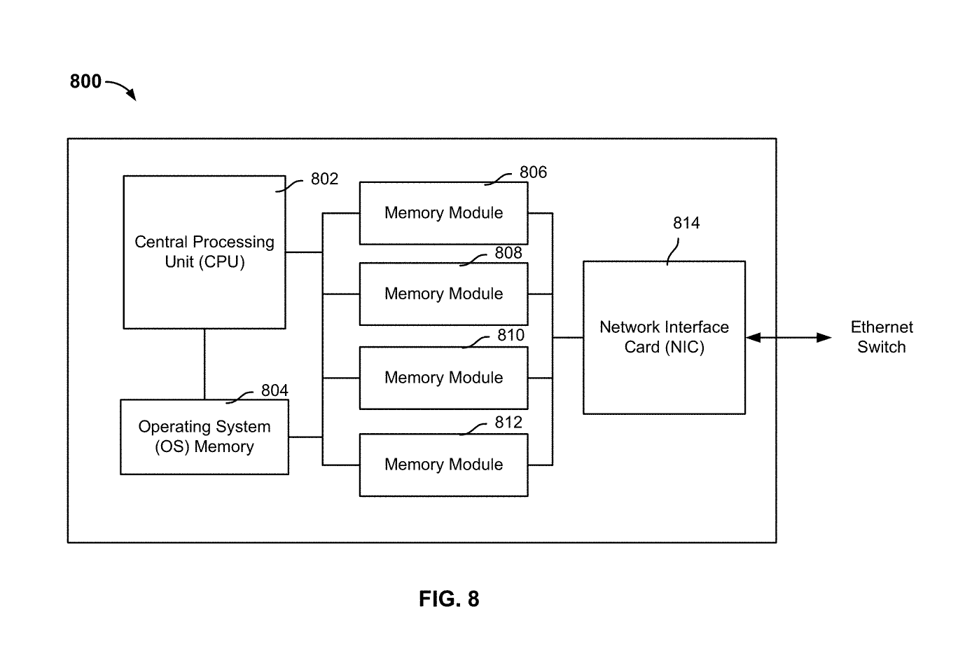

FIG. 8 is an example of a computation node. Computation node 800 includes central processing unit (CPU) 802, operating system (OS) memory 804, memory modules 806, 808, 810, and 812, and network interface card (NIC) 814 installed on a PBC. Although four memory modules are shown in computation node 800, more or fewer memory modules may be installed on a computation node in practice. Computation node 800 can be hot plugged into a disaggregated system.

In contrast to a conventional server, computation node 800 is in a similar form factor as a half-height full-length (HHFL) add-in-card (AIC). The measurements of the half-height full-length add-in-card are 4.2 in (height)×6.9 in (long). Further, in contrast to a conventional server, computation node 800 does not have a storage drive. Thus, the size of the motherboard of computation node 800 is much smaller than the size of a conventional server.

Each of memory modules 806, 808, 810, and 812 may comprise a high-speed dual in-line memory module (DIMM). CPU 802 comprises a single-socket CPU. CPU 802 is used to simplify the access to memory modules 806, 808, 810, and 812 and therefore achieve a reduced latency of memory modules 806, 808, 810, and 812. In some embodiments, CPU 802 comprises four or more cores. In the event that computation node 800 comprises the master computation node in a disaggregated system, the distributed file system could be stored at CPU 802. In some embodiments, memory modules 806, 808, 810, and 812 are installed with a sharp angle to PCB so that the thickness of computation node 800 is effectively controlled, which is beneficial to increase the rack density.

In some embodiments, OS memory 804 is implemented with NAND flash and is configured to provide the computer code associated with a local operating system to CPU 802 to enable CPU 802 to perform the normal functions of computation node 800. Because OS memory 804 is configured to store operating system code, OS memory 804 is read-only, unlike a typical SSD or HDD, which permits write operations. In some embodiments, because OS memory 804 is configured to store only operating system code, the storage capacity requirement of the memory is low, which reduces the overall cost of computation node 800. For example, the operating system run by CPU 802 can be Ubuntu or Linux. For example, the size of the computer code associated with the operating system can be 20 to 60 GB. After power-up, the instructions are loaded from OS memory 804 to memory modules 806, 808, 810, and 812 to enable computations to be performed by CPU 802. In some embodiments, NIC 814 comprises an Ethernet controller and is configured to send and receive packets over the Ethernet. For example, NIC 814 is directly connected to the Ethernet switch associated with the disaggregated system.

When more computation resource is needed in the disaggregated system, additional instances of computation node 800 can be added to the disaggregated system.

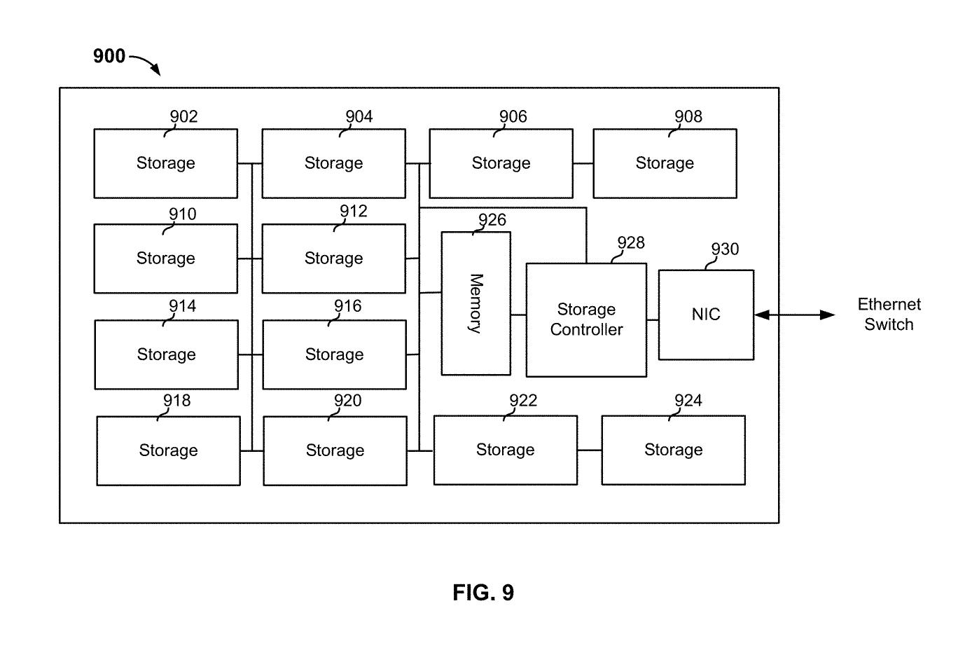

FIG. 9 is an example of a storage node. Storage node 900 includes storages 902, 904, 906, 908, 910, 912, 914, 916, 918, 920, 922, and 924, memory 926, storage controller 928, and NIC 930. Although 12 storages are shown in storage node 900, more or fewer storages may be installed on a storage node. Storage node 900 can be hot plugged into a disaggregated system.

In contrast to a conventional server, storage node 900 is in a similar form factor as a half-height full-length (HHFL) add-in-card (AIC). Further in contrast to a conventional server, storage node 900 does not have a CPU. Thus, the size of the motherboard of storage node 900 is much smaller than the size of a conventional server.

In some embodiments, storage controller 928 comprises a NAND controller and each of storage devices 902, 904, 906, 908, 910, 912, 914, 916, 918, 920, 922, and 924 comprises a (e.g., 256 GB) NAND flash chip. Each of storage devices 902, 904, 906, 908, 910, 912, 914, 916, 918, 920, 922, and 924 is configured to store data that is assigned to be stored at storage node 900. Unlike a (e.g., flash) storage drive which includes several NAND flash chips, each of storage devices 902, 904, 906, 908, 910, 912, 914, 916, 918, 920, 922, and 924 can comprise a single NAND flash ship and the storage devices are collectively managed by storage controller 928. In some embodiments, storage controller 928 comprises one or more microprocessors inside. The microprocessor(s) included in storage controller 928 handle the Ethernet protocol and the NAND storage management. In some embodiments, memory 926 comprises volatile memory such as dynamic random-access memory (DRAM). Memory 926 is configured to serve as the data bucket of the microprocessors of storage controller 928 to accomplish the protocol exchange, data framing, coding, mapping, etc. In some embodiments, memory 926 is also configured to provide instructions to storage controller 928 and storage devices 902, 904, 906, 908, 910, 912, 914, 916, 918, 920, 922, and 924. In some embodiments, network interface controller (NIC) 930 comprises an Ethernet controller and is configured to send and receive packets over the Ethernet. For example, NIC 930 is directly connected to the Ethernet switch associated with the disaggregated system. Since the disaggregated system has a common BBU to support the system, the power failure protection of each single component (e.g., storage devices 902, 904, 906, 908, 910, 912, 914, 916, 918, 920, 922, and 924) on storage node 900 is not necessary.

In various embodiments, one or more computation nodes, such as computation node 800 of FIG. 8, and one or more storage nodes, such as storage node 900, are included in a disaggregated system and configured to collectively perform one or more functions. The storage and/or computation nodes of the disaggregated system share a set of common equipment that includes OOB data equipment.

When more storage resource is needed in the disaggregated system, additional instances of storage node 900 can be added to the disaggregated system.

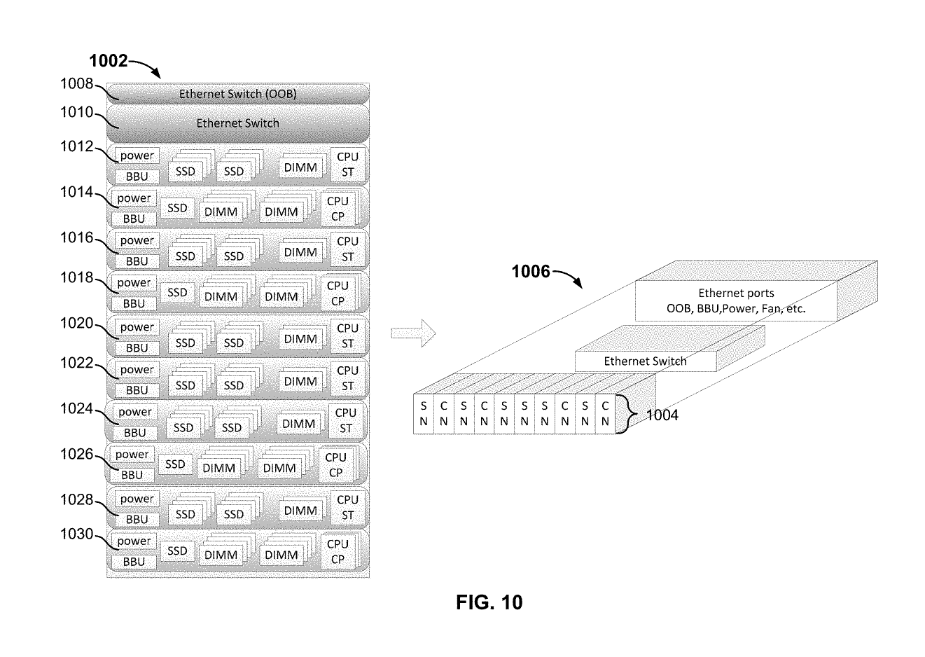

FIG. 10 shows a comparison between an example conventional server rack and an example disaggregated system. The example of FIG. 10 shows example conventional server rack 1002 and example disaggregated system 1006. Conventional server rack 1002 includes Ethernet switch (OOB) 1008 and Ethernet switch 1010. Ethernet switch (OOB) 1008 is configured to monitor and control communication but not for production or workload. Ethernet switch 1010 is configured to receive and distribute normal network traffic for conventional server rack 1002. Conventional server rack 1002 also includes conventional storage servers 1012, 1016, 1020, 1022, 1024, and 1028 and conventional computation servers 1014, 1018, 1026, and 1030. As shown in the diagram, each conventional computation server and storage server includes a corresponding power source (“power”) and BBU. Furthermore, each conventional computation server and storage server also includes a corresponding CPU. (CPUs included in a conventional computation server are labeled as “CPU ST” in the diagram and CPUs included in a conventional storage server are labeled as “CPU CP” in the diagram). Generally, because a conventional storage server is designed mainly for storage purposes, the conventional storage server's CPU may not need to perform top-level computation performance. As such, the frequency and the number of cores for the CPU in a conventional storage server may only need to meet a relatively relaxed requirement. However, to make the conventional storage server work, the CPU is still inevitable. Similarly, the DRAM DIMMs are also installed in a traditional storage server. Multiple storage units (solid state drives or SSDs) are equipped in the servers to provide the high capacity for data storage. A conventional computation server is generally configured with a high-performance CPU and large-capacity DRAM DIMMs. On the other hand, the conventional computation server's need for storage space is generally not critical, so few SSDs are equipped mainly for data caching purposes.

Below are some contrasting aspects between conventional server setup 1002 and disaggregated system 1006:

Each storage node (which is labeled as “S N” in the diagram), which can be implemented using the example storage node of FIG. 9, of disaggregated system 1006 does not include a CPU and corresponding DRAM DIMM. Instead, each storage node of disaggregated system 1006 includes an embedded microprocessor (inside a storage (e.g., NAND) controller) and a small amount of on-board volatile memory (e.g., DRAM). In some embodiments, the embedded microprocessor and the DRAM of a storage node work together to store and retrieve data from the NAND storages on the storage node. By shrinking the motherboard in a storage node, the complexity and the cost of each storage node are reduced.

Each computation node (which is labeled as “C N” in the diagram), which can be implemented using the example computation node of FIG. 8, of disaggregated system 1006 does not include a storage drive (e.g., an SSD or an HDD). Instead, one onboard OS NAND can be stored on each computation node with a small storage capacity that serves as the local boot drive. The motherboard is also simplified since there are few kinds of peripheral devices. As a result, the work on the design, signal integrity, and power integrity on a computation node can be reduced too.

In disaggregated system 1006, common external equipment such as BBU, OOB, power supply, and fan, for example, are now converged together to be shared by all the computation and/or storage nodes in disaggregated system 1006, which saves significant server rack space and resources such as the server chassis, power cord, and rack rail, for example.

Disaggregated system 1006 also occupies significantly less space on a server rack space. Whereas a conventional server, including the Ethernet components, occupied an entire server rack, height 1004 of disaggregated system 1006 is only a predetermined portion (e.g., two rack units) of the height of the server rack, so more than one disaggregated system 1006 can be installed on a single server rack, which enhances the rack density and improves thermal dissipation of the server rack.

Power reduction is another improvement provided by disaggregated system 1006. The power saving is from the simplifications made on the storage node's CPU-memory complex, the computation node's SSD, and deduplicating modules in the traditional rack such as one or more fans, one or more power supplies, one or more BBUs, and one or more OOBs, for example.

Another advantage of the disaggregated system is to use the converged BBU to simplify the design of each storage node and computation node. Because the whole disaggregated system now is protected by the BBU, the individual power failure protection designs on devices like the SSD(s), the RAID controller(s), and other certain intermediate caches are no longer necessary. The conventional manner of power failure protection that requires the installation or presence of protection at all levels and/or with respect to individual components is considered as sub-optimal due to its greater cost and overall fault rate.

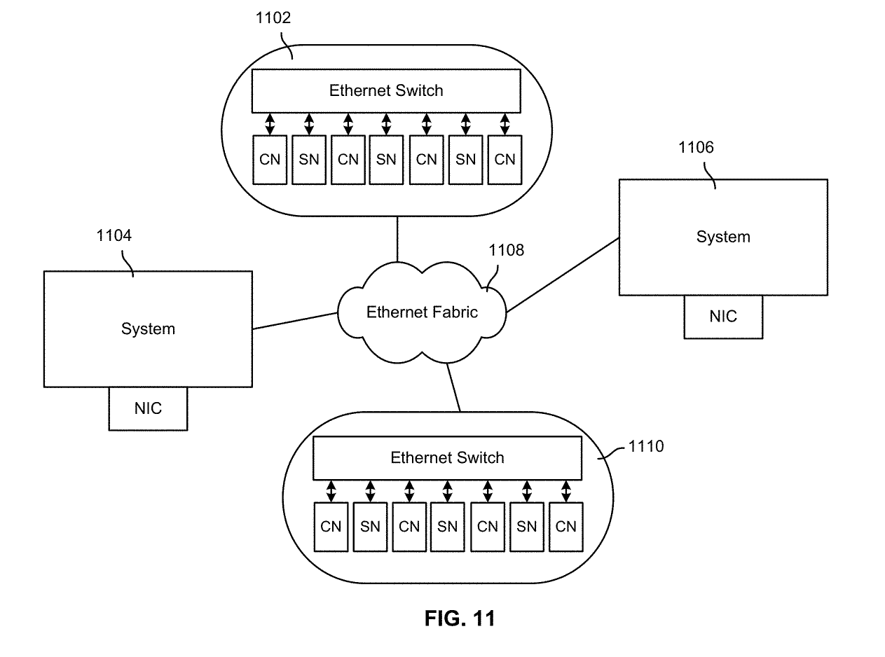

FIG. 11 is a diagram showing example disaggregated systems connected to other systems in a data center. As shown in the diagram, each of disaggregated systems 1102 and 1110 includes an Ethernet switch that fulfills the top of rack (TOR) functionality. As such, each of disaggregated systems 1102 and 1110 can be connected to the other systems, systems 1104 and 1106, of the data center via Ethernet fabric 1108. Systems 1104 and 1106 may each comprise a conventional server or a disaggregated system.

As described above, a disaggregated system may be dynamically formed with any combination of at least one computation node and any number of storage nodes to accommodate the function that is to be performed by the disaggregated systems. As such, the disaggregated system is highly reconfigurable, flexible, and convenient. The disaggregated system is widely compatible with the current data center infrastructure via its high-level abstraction and compliance with the broadly-adopted Ethernet fabric. The disaggregated system can be considered as a reconfigurable computation and storage resources box that is equipped with high-speed Ethernet plugged into the infrastructure. For example, when all nodes in a disaggregated system other than the master computation node are the storage nodes, this disaggregated system can serve as a storage array like network-attached storage (NAS). On the other hand, when the disaggregated system includes all computation nodes, the system will have a large capacity for performing computation and data exchange through the high-speed network of a data center.

The disaggregated system with an Ethernet switch as described herein has the advantages of being efficiently reconfigurable, low-power, low-cost, and equipped with a high-speed interconnect. Furthermore, the disaggregated system improves enhanced rack density. The disaggregated system reduces the total cost of ownership (TCO) of large scale infrastructure by enabling upgrades of servers through configuration flexibility, as well as the removal of redundant modules. Meanwhile, the sub-systems of the disaggregated system have been carefully studied to simplify the individual nodes. Furthermore, the disaggregated system is built with the strong compatibility with the existing infrastructure so that it can be directly added into the data center without major architectural changes.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A disaggregated system, comprising:
one or more computation nodes, wherein each of the one or more computation nodes does not include a storage drive configured to store data, and wherein each of the one or more computation nodes comprises:
a central processing unit (CPU);
a storage device coupled to the CPU and configured to provide the CPU with operating system code;
a plurality of memories configured to the CPU and configured to provide the CPU with instructions; and
a computation node networking interface coupled to a switch and configured to communicate with at least one or more storage nodes included in the disaggregated system;
the one or more storage nodes, wherein each of the one or more storage nodes does not is include a corresponding CPU, wherein each of the one or more storage nodes comprises:
a plurality of storage devices configured to store data;
a controller coupled to the plurality of storage devices and configured to control the plurality of storage devices;
a memory coupled to the controller configured to storage data received from the controller; and
a storage node networking interface coupled to the switch and configured to communicate with at least the one or more computation nodes; and
the switch coupled to the one or more computation nodes and the one or more storage nodes and configured to facilitate communication among the one or more computation nodes and the one or more storage nodes.

2. The system of claim 1, wherein each of the one or more computation nodes or the one or more storage nodes is configured to be hot plugged into the system.

3. The system of claim 1, wherein at least one of the one or more computation nodes comprises a master computation node, wherein the master computation node is configured to:
receive a request from a requestor;
distribute at least a portion of the request to another computation node of the one or more computation nodes;
receive at least a portion of a response to the request from the other computation node; and
send the at least portion of the response to the requestor.

4. The system of claim 1, wherein at least one of the one or more computation nodes comprises a master computation node, wherein the master computation node is configured with a distributed file system, wherein the distributed file system is configured to track which of the one or more computation nodes stores which one or more portions of a file, wherein the master computation node is configured to:
receive a request from a requestor;
distribute at least a portion of the request to another computation node of the one or more computation nodes;
is receive at least a portion of a response to the request from the other computation node; and
send the at least portion of the response to the requestor.

5. The system of claim 1, wherein each of the one or more computation nodes is associated with a height of two rack units.

6. The system of claim 1, wherein the one or more computation nodes and the one or more storage nodes share a set of external equipment.

7. The system of claim 1, wherein the one or more computation nodes and the one or more storage nodes share a set of external equipment, wherein the set of external equipment comprises one or more of the following: a fan, a backup battery unit, an out of band communication system, a cooling system, a power distribution unit, a secondary power supply, and a power generator.

8. The system of claim 1, wherein the one or more computation nodes and the one or more storage nodes are configured to face a cold aisle in a data center.

9. The system of claim 1, wherein a new computation node or a new storage node is configured to be dynamically added to the disaggregated system in the event that a condition for adding a new node is met.

10. The system of claim 1, wherein an existing computation node or an existing storage node s is configured to be dynamically removed from the disaggregated system in the event that a condition for removing an existing node is met.

11. The system of claim 1, wherein the controller comprises one or more microprocessors.

12. The system of claim 1, wherein the plurality of storage devices comprises a plurality of NAND storage devices.

13. A method for processing a request, comprising:
receiving, at a first computation node of one or more computation nodes of a disaggregated system, a request from a requestor;
distributing at least a portion of the request to a second computation node of the one or more computation nodes;
receiving at least a portion of a response to the request from the second computation node; and
sending the at least portion of the response to the requestor,
wherein the first computation node comprises:
a central processing unit (CPU);
a storage device coupled to the CPU and configured to provide the CPU with operating system code;
a plurality of memories configured to the CPU and configured to provide the CPU with instructions; and
a computation node networking interface coupled to a switch and configured to communicate with at least one or more storage nodes included in the disaggregated system.

14. The method of claim 13, further comprising:
identifying a first storage node of the one or more storage nodes that stores data related to the request; and
requesting the data related to the request from the first storage node.

15. The method of claim 13, further comprising selecting the second computation node to distribute the at least portion of the request to based at least in part on a feedback received from the second computation node.

16. The method of claim 13, wherein the first computation node does not include a storage drive configured to store data.

17. The method of claim 13, wherein a first storage node of the one or more storage nodes included in the disaggregated system comprises:
a plurality of storage devices configured to store data;
a controller coupled to the plurality of storage devices and configured to control the plurality of storage devices;
a memory coupled to the controller configured to storage data received from the is controller; and
a storage node networking interface coupled to the switch and configured to communicate with at least the one or more computation nodes.

18. The method of claim 13, wherein a first storage node of the one or more storage nodes does not include a CPU.
